(19) United States
(12) Patent Application Publication
(10) Pub. No.: US 2017/0182636 A1
(43) Pub. Date: Jun. 29, 2017

(54) PRECISION PROTECTION JIG WITH FAT U-SHAPED BASE

(71) Applicant: VISION WIDE TECH CO., LTD., Taichung City (TW)

(72) Inventors: Sheng-Hsun HUNG, Taichung City (TW); Sung-Chiang CHEN, Taichung City (TW); I-Chung LIU, Taichung City (TW)

(73) Assignee: Vision Wide Tech Co., Ltd.

(21) Appl. No.: 14/982,388

(22) Filed: Dec. 29, 2015

(51) Int. Cl. B25B 11/00

(52) U.S. Cl. CPC B25B 11/00

(57) ABSTRACT

A precision protection jig with a base is provided and includes: a platform having its two ends provided with a first end portion and a second end portion, respectively, wherein a table connects bottoms of the first and second end portions, and a connection block is appropriately positioned on inner wall surfaces of the first and second end portions; a horizontal support jig having two ends provided with two connection plates, respectively, such that the connection plates allow the horizontal support jig to be transversely connected to the connection block of the first and second end portions, respectively; and a vertical support jig having two ends connected to the horizontal support jig and the table centrally and perpendicularly, respectively, wherein the horizontal support jig exerts lateral stress upon the first and second end portions, whereas the vertical support jig produces vertical stress.

### BACKGROUND OF THE INVENTION

Technical Field

The present invention relates to platform protection mechanisms and more particularly to a precision protection jig with a base.

Description of Related Art

Referring to FIG. 1, a conventional planer processing apparatus has a platform unit 1. A vertical end portion 2 is disposed at each of the two ends of the platform unit 1. A table 3 connects the bottoms of the two vertical end portions 2. The table 3 and the two vertical end portions 2 together define a receiving space 4. At least one hanging portion 5 is disposed on the inner wall surface of each vertical end portion 2.

If a user hangs the at least one hanging portion 5 disposed on the inner wall surface of each vertical end portion 2 on at least one hanger (not shown) for the sake of transport, the platform unit 1 will deform when overloaded or as a temperature accuracy tolerance.

The present invention aims to overcome the aforesaid drawback of the prior art, that is, a platform unit of a conventional planer processing apparatus in operation deforms and bends when overloaded.

### SUMMARY

The present invention provides a precision protection jig with a base to prevent a platform thereof in operation from deforming and bending.

In order to achieve the above and other objectives, the present invention provides a precision protection jig with a base, comprising: a platform having its two ends provided with a first end portion and a second end portion, respectively, wherein a table connects a bottom of the first end portion and a bottom of the second end portion, and at least one connection block is appropriately positioned on inner wall surfaces of the first end portion and the second end portion; a horizontal support jig having two ends provided with two connection plates, respectively, such that the connection plates allow the horizontal support jig to be transversely connected to the at least one connection block of the first end portion and the second end portion, respectively; and a vertical support jig having two ends connected to the horizontal support jig and the table, respectively, wherein the horizontal support jig exerts lateral stress upon the first end portion and second end portion, whereas the vertical support jig disposed at the middle positions of the horizontal support jigs and connected thereto perpendicularly produces vertical stress. Hence, even when overloaded or subjected to a temperature difference, the platform in operation does not deform or bend.

Preferably, the connection block comprises a first member and a second member, with the first and second members having at least one first fixing hole and at least one second fixing hole, respectively, with the connection plates each having at least one third fixing hole corresponding in position to the first fixing holes, respectively, wherein at least one fourth fixing hole corresponding in position to the second fixing holes is disposed on the inner wall surfaces of the first end portion and the second end portion, wherein the first fixing holes are engaged with the third fixing holes by at least one first fixing element, wherein the second fixing holes are engaged with the fourth fixing holes by at least one second fixing element.

Preferably, the first member has a first joint surface and a second joint surface, wherein the second member has a third joint surface and a fourth joint surface which correspond in position to the first joint surface and the second joint surface, wherein the first joint surface and the third joint surface have at least one fifth fixing hole, respectively, wherein the fifth fixing holes are engaged by at least one third fixing element.

Preferably, the vertical support jig is provided in the number of two, with the vertical support jigs being of different lengths, wherein the first end portion, the second end portion and the table together define a receiving space, and the receiving space is further defined with a first plane and a second plane having different heights and underpinning the vertical support jigs of different lengths, respectively.

### BRIEF DESCRIPTION OF THE SEVERAL VIEWS OF THE DRAWINGS

FIG. 1 is a perspective view of a conventional planer processing apparatus;

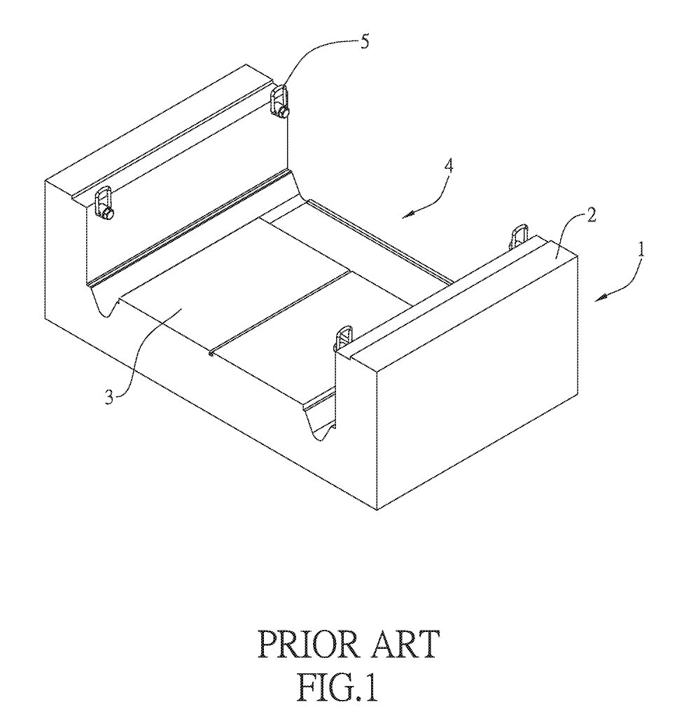

FIG. 2 is an exploded view of a preferred embodiment of the present invention;

FIG. 3 is a partial exploded view of the preferred embodiment of the present invention;

FIG. 4 is an assembled perspective view of the preferred embodiment of the present invention;

FIG. 5 is a top view of the preferred embodiment of the present invention;

FIG. 6 is a front view of the preferred embodiment of the present invention; and

FIG. 7 is a lateral cross-sectional view of the preferred embodiment of the present invention.

### DETAILED DESCRIPTION OF THE EMBODIMENT OF THE INVENTION

To render the objectives, features and advantages of the present invention more comprehensible, the present invention is illustrated with diagrams and described hereunder.

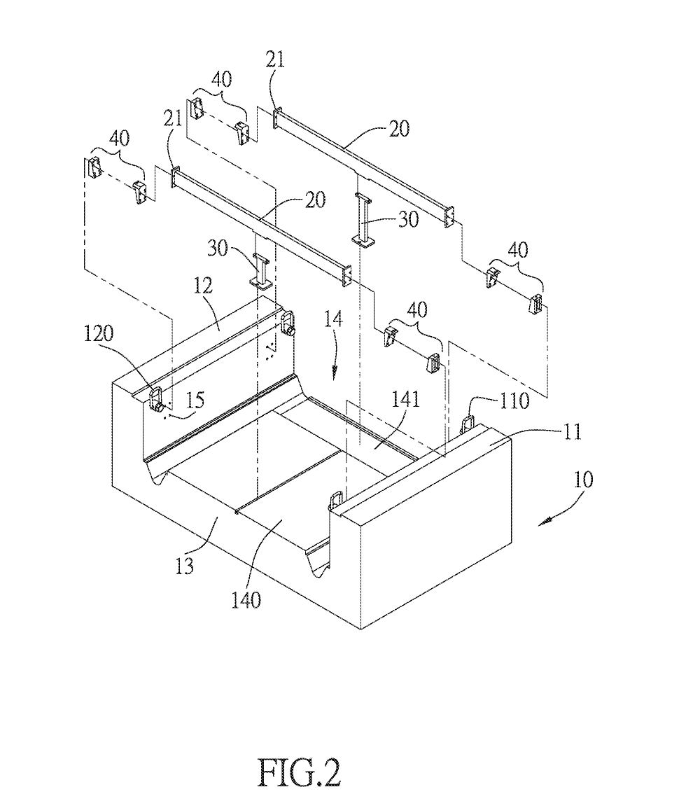

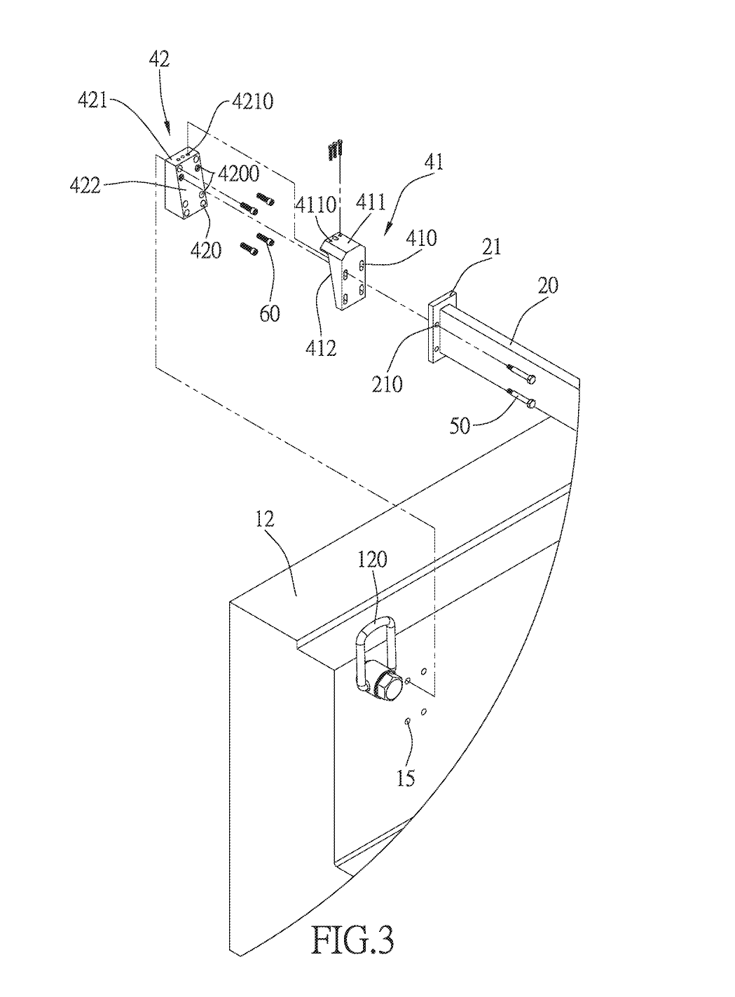

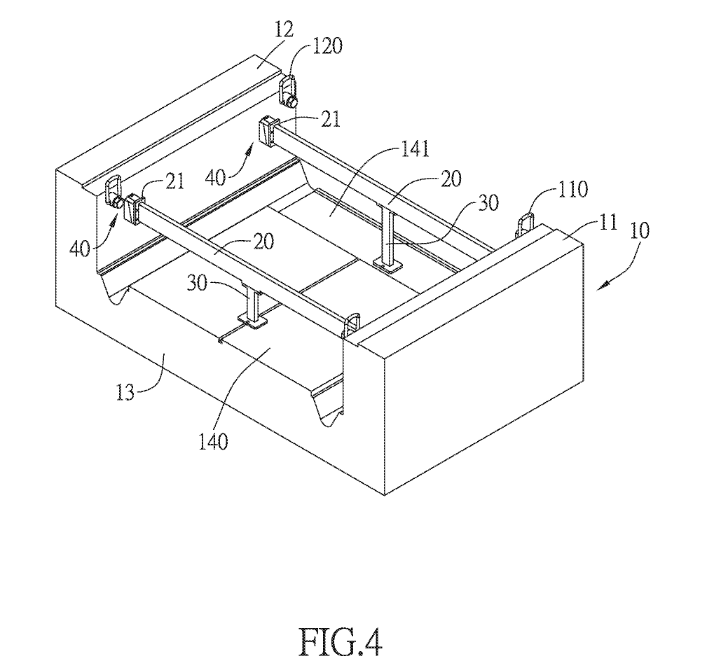

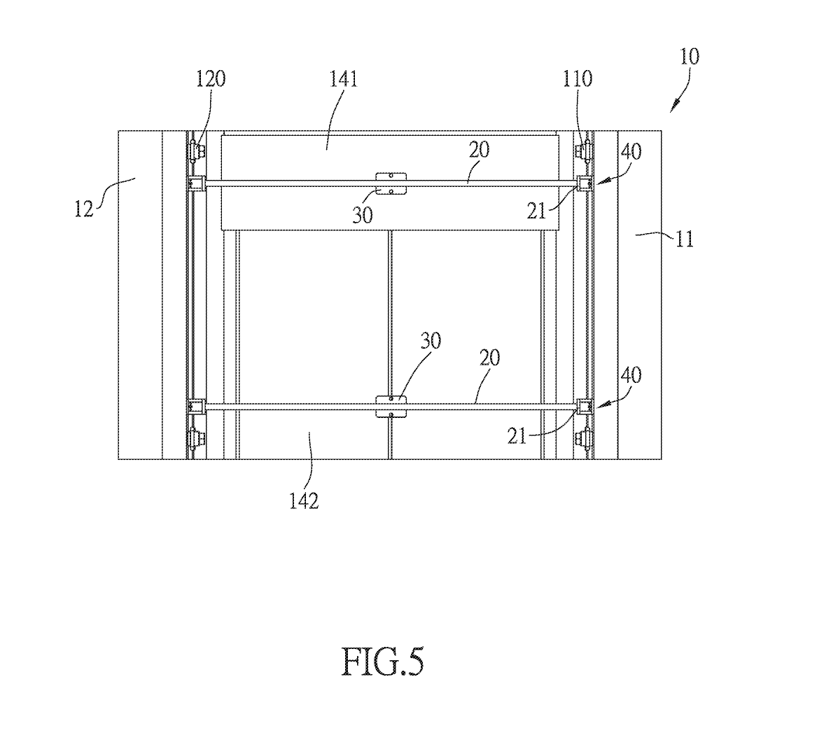

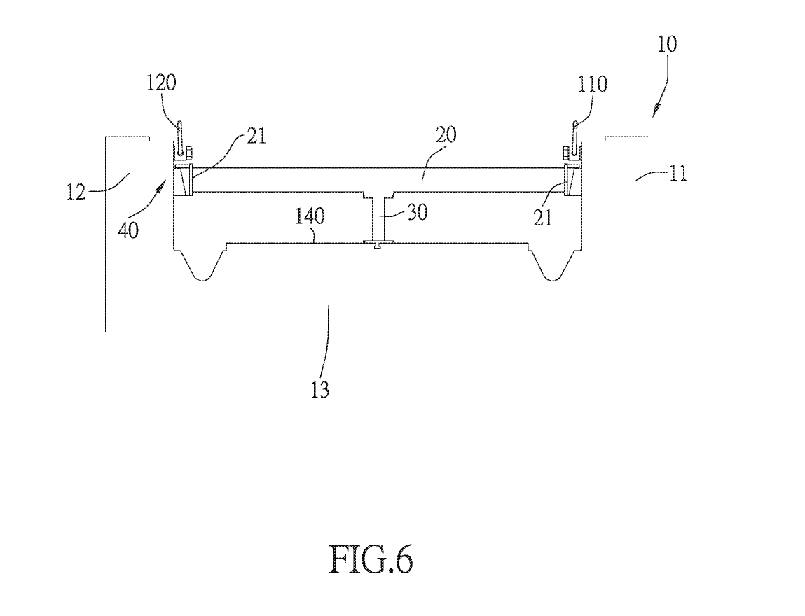

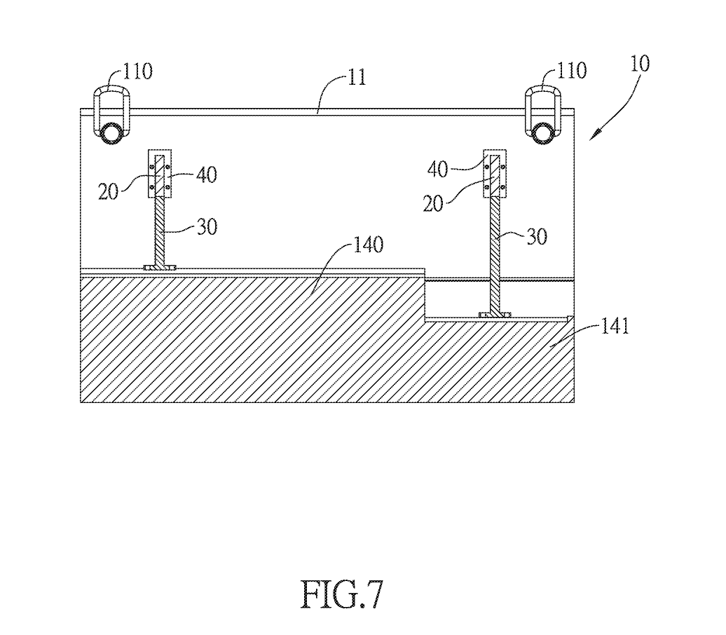

Referring to FIGS. 2-7, the present invention provides a precision protection jig with a base, comprising a platform 10, a horizontal support jig 20, and a vertical support jig 30.

The platform 10 has its two ends provided with a first end portion 11 and a second end portion 12, respectively. A table 13 connects the bottom of the first end portion 11 and the bottom of the second end portion 12 such that the table 13, the first end portion 11 and the second end portion 12 together define a receiving space 14. The receiving space 14 is further defined with a first plane 140 and a second plane 141 which are of different heights. At least one hanging portion 110, 120 and at least one fourth fixing hole 15 are disposed on inner wall surfaces of the first end portion 11 and the second end portion 12, respectively.

In this embodiment, the first end portion 11 and the second end portion 12 are perpendicular to the table 13.

The horizontal support jig 20 is transversely disposed on the first end portion 11 and second end portion 12 of the platform 10. A connection plate 21 is disposed at each of the two ends of the horizontal support jig 20.

In this embodiment, there are two horizontal support jigs 20.

The two ends of the vertical support jig 30 are connected to the horizontal support jig 20 and the table 13, respectively.

In this embodiment, there are two vertical support jigs 30, and the vertical support jigs 30 are of different lengths. The shorter vertical support jig 30 is disposed on the first plane 140 which is higher than the second plane 141. The long vertical support jig 30 is disposed on the second plane 141 which is lower than the first plane 140. Since the first plane 140 and second plane 141 are of different heights, the at least two vertical support jigs 30 underpin the at least two horizontal support jigs 20 at the same height and at the middle positions.

A connection block 40 (provided in the number of at least one in this embodiment) comprises a first member 41 and a second member 42. The first member 41 and the second member 42 have at least one first fixing hole 410, 420, respectively. The second member 42 further has at least one second fixing hole 4200 corresponding in position to the at least one fourth fixing hole 15. The connection plates 21 of the horizontal support jigs 20 each have at least one third fixing hole 210 corresponding in position to the first fixing holes 410, 420, respectively.

The first fixing holes 410, 420 are engaged with the third fixing holes 210 by at least one first fixing element 50. The at least one second fixing hole 4200 is engaged with the fourth fixing holes 15 by at least one second fixing element 60.

The first member 41 has a first joint surface 411 and a second joint surface 412. The second member 42 has a third joint surface 421 and a fourth joint surface 422 which correspond in position to the first joint surface 411 and the second joint surface 412, respectively. The first joint surface 411 and the third joint surface 421 have at least one fifth fixing hole 4110, 4210, respectively. The fifth fixing holes 4110, 4210 are engaged by at least one third fixing element 70.

In this embodiment, the second joint surface 412 and the fourth joint surface 422 are oblique surfaces which match.

When a user hangs the hanging portions 110, 120 on the inner wall surfaces of the first end portion 11 and the second end portion 12 at hangers (not shown), the horizontal support jig 20 exerts lateral stress upon the first end portion 11 and second end portion 12, whereas the vertical support jigs 30 disposed at the middle positions of the horizontal support jigs 20 and connected thereto perpendicularly produce vertical stress. Hence, even when overloaded or subjected to a temperature difference, the platform 10 in operation does not deform or bend in any manner, for example, allowing the first end portion 11 and second end portion 12 to deform and bend laterally.

With the connection block 40 comprising the first and second members 41, 42, and the first and second members 41, 42 having the first, second, third and fourth joint surfaces 411, 412, 421, 422, respectively, the user loosens the first, second and third fixing elements 50, 60, 70 to thereby fine-tune the joint positions of the first, second, third and fourth joint surfaces 411, 412, 421, 422, thus allowing the connection plate 21 of the horizontal support jig 20 to get engaged with the connection block 40 smoothly.

In conclusion, the above preferred embodiments and drawings are illustrative rather than restrictive of the present invention. Therefore, all equivalent changes and modifications made to the above preferred embodiments according to the claims of the present invention shall fall within the scope of the claims of the present invention.

1. A precision protection jig with a base, comprising:
a platform provided with a first end portion and a second end portion at two ends thereof, respectively, wherein a table connects a bottom of the first end portion and a bottom of the second end portion, and at least a connection block is positioned on inner wall surfaces of the first end portion and the second end portion;
a horizontal support jig provided with two connection plates at two ends thereof, respectively, such that the connection plates allow the horizontal support jig to be transversely connected to the connection block of the first end portion and the second end portion, respectively; and
a vertical support jig having two ends connected to the horizontal support jig and the table, respectively.

2. The precision protection jig according to claim 1, wherein the connection block comprises a first member and a second member, the first and second members have at least a first fixing hole and at least a second fixing hole, respectively, the connection plates each has at least a third fixing hole corresponding in position to the first fixing holes, respectively, at least a fourth fixing hole corresponding in position to the second fixing holes is disposed on the inner wall surfaces of the first end portion and the second end portion, the first fixing holes are engaged with the third fixing holes by at least a first fixing element, the second fixing holes are engaged with the fourth fixing holes by at least a second fixing element.

3. The precision protection jig according to claim 2, wherein the first member has a first joint surface and a second joint surface, the second member has a third joint surface and a fourth joint surface which correspond in position to the first joint surface and the second joint surface, the first joint surface and the third joint surface have at least a fifth fixing hole, respectively, the fifth fixing holes are engaged by at least a third fixing element.

4. The precision protection jig according to claim 3, wherein the second joint surface and the fourth joint surface are oblique surfaces which match.

5. The precision protection jig according to claim 1, wherein there are two said vertical support jigs, the vertical support jigs have different lengths, the first end portion, the second end portion and the table together define a receiving space, and the receiving space is further defined with a first plane and a second plane having different heights and underpinning the vertical support jigs of different lengths, respectively.

6. The precision protection jig according to claim 1, wherein there are two said horizontal support jigs.

7. The precision protection jig according to claim 1, wherein the first end portion and the second end portion are perpendicular to the table, the first end portion and the second end portion each has at least a hanging portion.

8. (canceled)
